(19) United States
(12) Patent Application Publication
(10) Pub. No.: US 2026/0364836 A1
(43) Pub. Date: Nov. 19, 2026

(54) SHAVING DEVICE

(71) Applicant: Manscaped, LLC, Las Vegas, NV (US)

(72) Inventor: Shlomo ZUCKER, Mikhmoret (IL)

(21) Appl. No.: 19/130,267

(22) PCT Filed: Nov. 16, 2023
(86) PCT No.: PCT/IL2023/051186

§ 371 Date: May 15, 2025

Related U.S. Application Data
(60) Provisional application No. 63/427,119, filed on Nov. 22, 2022.

(51) Int. Cl. B26B 21/40; B26B 21/22

(52) U.S. Cl. CPC B26B 21/40; B26B 21/22

(57) ABSTRACT

The invention relates to a shaving device for shaving a surface, comprising a handle, comprising an elongated body having a proximal end and a distal end; and a shaving head, reversibly connected to the distal end of the handle, the shaving head comprising a blade holder comprising a bottom side for connecting at least two blades; at least two blades, each comprising at least one sharp end; two wheels, each located adjacent the at least one sharp end of each at least two blades; where the bottom side of said blade holder comprises an angle that position each of the at least two blades at an angle between about 1 degree and about 10 degrees in relation to said surface being shaved.

### RELATED APPLICATION/S

This application claims the benefit of priority of U.S. Provisional Patent Application No. 63/427,119 filed on Nov. 22, 2022, the contents of which are incorporated herein by reference in their entirety.

### FIELD AND BACKGROUND OF THE INVENTION

The present invention, in some embodiments thereof, relates to a shaving device and, more particularly, but not exclusively, to a shaving device for the body.

Additional background art includes U.S. Patent Application Publication No. 20180111280A1 disclosing a shaver having a handle and a shaver head extending from an end of the handle. The shaver head includes a head housing having a base and a shelf that define a space therebetween, a roller wheel positioned partially inside the space and having a corrugated arrangement of parallel ridges that define channels between adjacent ridges, a plurality of blades secured to the shelf, with the blades partially covering the roller wheel so as to expose a portion of the roller wheel adjacent the plurality of blades, and a blade cover secured over the plurality of blades.

U.S. Pat. No. 10,513,041B2 disclosing a shaving apparatus having a body including a central lumen and one or more rolling elements are rotatingly attached to the bottom surface of the shaving apparatus. The apparatus includes a shaving head assembly rotatably attachable within the central lumen. The shaving head assembly includes one or more shaving blades and a blade cartridge attachment arm for attachment of the blade cartridge to a mounting shaft having a bearing surface. The shaving head assembly, or a subunit thereof, rotates about an axis of rotation defined by the major axis of the mounting shaft. One or more engagement elements removably retain the shaving head assembly within the central lumen, and a mechanical release mechanism which includes an actuator, is provided to remove the shaving head assembly.

U.S. Pat. No. 7,086,160B2 disclosing in a razor cartridge, a platform portion has a first cartridge section that includes at least one first pair of razor blades position therein. Each of the first pair or razor blades has an at least partially exposed cutting edge. A second cartridge section is also provided and is coupled to the platform portion. The second cartridge section includes at least one pair of second razor blades positioned therein, each of the second pair of razor blades also has an at least partially exposed cutting edge. The razor cartridge can be mounted either temporarily or permanently to a handle and the cutting edges of each of the first and second pair of razor blades face one another so that during a shaving operation, the razor cartridge can cut hair when drawn over a user's skin in either of two generally opposite directions.

U.S. Pat. No. 7,140,115B2 disclosing shavers that are particularly applicable to shaving a user's head, but that may be utilized for shaving any part of the body. More specifically, a shaver according to the present invention has one or more of the following elements: a wheel or other rolling device on the same side of the shaver as the razor blade or other shaving component, an adjustable finger hook for accommodating fingers of different sizes, and an attached stand for supporting the razor blade or other shaving component when the shaver is set down.

### SUMMARY OF THE INVENTION

Following is a non-exclusive list including some examples of embodiments of the invention. The invention also includes embodiments which include fewer than all the features in an example and embodiments using features from multiple examples, also if not expressly listed below.

### EXAMPLE 1

A shaving device for shaving a surface, comprising:
a. a handle, comprising an elongated body having a proximal end and a distal end; and
b. a shaving head, reversibly connected to said distal end of said handle, said shaving head comprising:
   i. a blade holder comprising a bottom side for connecting at least two blades;
   ii. at least two blades, each comprising at least one sharp end;
   iii. two wheels, each located adjacent said at least one sharp end of each said at least two blades;
wherein said bottom side of said blade holder comprises an angle that position each of said at least two blades at an angle between about 1 degree and about 10 degrees in relation to said surface being shaved.

### EXAMPLE 2

The shaving device according to example 1, wherein said angle is of 5 degrees.

### EXAMPLE 3

The shaving device according to example 1 or example 2, wherein said shaving head comprises one blade having two sharp ends.

### EXAMPLE 4

The shaving device according to any one of examples 1-3, wherein said two wheels comprise a plurality of small wheels distanced by a plurality of spaces.

### EXAMPLE 5

The shaving device according to example 4, wherein a width of each said plurality of small wheels is from about 0.2 mm to about 0.6 mm.

### EXAMPLE 6

The shaving device according to example 4, wherein a width of each said plurality of small wheels is of 0.6 mm.

### EXAMPLE 7

The shaving device according to example 4, wherein each of said plurality of spaces is from about 1 mm to about 4 mm.

### EXAMPLE 8

The shaving device according to any one of examples 1-7, wherein said shaving head is configured to tilt along a longitudinal axis of said shaving head, said longitudinal axis meeting a location where said handle connects to said shaving head.

### EXAMPLE 9

The shaving device according to example 8, wherein said tilt is at an angle of from about ±1° to about ±90°.

### EXAMPLE 10

The shaving device according to example 8, wherein said shaving head freely rotates along said longitudinal axis.

### EXAMPLE 11

The shaving device according to any one of examples 1-10, wherein said handle comprises a two arm structure configured to interlock with sides of said shaving head for performing reversibly connection.

### EXAMPLE 12

The shaving device according to example 11, wherein said two arm structure is adjustable.

### EXAMPLE 13

The shaving device according to any one of examples 1-12, wherein said blade holder further comprises a base, wherein said bottom side is a bottom side of said base, and further comprising a rib extending vertically from a center of said base.

### EXAMPLE 14

The shaving device according to any one of examples 1-13, wherein said two wheels are configured to rotate freely.

### EXAMPLE 15

The shaving device according to any one of examples 1-14, wherein each of said two wheels comprise a diameter of from about 1 mm to about 20 mm.

### EXAMPLE 16

The shaving device according to any one of examples 1-15, wherein each of said two wheels comprise a diameter of 5 mm.

### EXAMPLE 17

The shaving device according to any one of examples 1-16, wherein said shaving device further comprises two cover holders configured to provide support for the parts of said shaving head.

### EXAMPLE 18

The shaving device according to example 17, wherein each of said two cover holders comprise a plurality of openings conjured to engage parts of said shaving head.

### EXAMPLE 19

The shaving device according to any one of examples 1-18, wherein said shaving head comprises a width of from about 10 mm to about 100 mm.

### EXAMPLE 20

The shaving device according to any one of examples 1-19, wherein said shaving head comprises a width of 23 mm.

### EXAMPLE 21

The shaving device according to any one of examples 1-20, wherein said shaving head comprises a width of 46.2 mm.

### EXAMPLE 22

The shaving device according to any one of examples 1-21, wherein said shaving head comprises a depth of from about 3 mm to about 50 mm.

### EXAMPLE 23

The shaving device according to any one of examples 1-22, wherein said shaving head comprises a depth of 12 mm.

### EXAMPLE 24

The shaving device according to any one of examples 1-23, wherein said shaving head comprises a height of from about 1 mm to about 20 mm.

### EXAMPLE 25

The shaving device according to to any one of examples 1-24, wherein said shaving head comprises a height of 6.77 mm.

### EXAMPLE 26

The shaving device according to any one of examples 1-25, wherein said handle comprises one or more ergonomic elements.

### EXAMPLE 27

The shaving device according to any one of examples 1-26, further comprising a protective cover configured for covering said at least two blades.

### EXAMPLE 28

The shaving device according to any one of examples 1-27, wherein some blades from said at least two blades face to one direction while some other blades from said at least two blades face to an opposite direction.

### EXAMPLE 29

The shaving device according to any one of examples 1-28, wherein all blades from said at least two blades face a same direction.

### EXAMPLE 30

The shaving device according to any one of examples 1-29, at least one of said two wheels comprises a lubricant sheet covering said at least one wheel and configured to rotate and release lubricant materials while said shaving device is being used. Example 31. A kit for shaving, comprising:
a. an adjustable handle according to example 1; and
b. a plurality of shaving heads, according to example 1;
   wherein said plurality of heads comprise different sizes.

### EXAMPLE 32

The kit for shaving according to example 31, wherein each of said plurality of shaving heads comprise a length of 5 mm, 10 mm, 20 mm, 23 mm, 45 mm, 46.2 mm, 50 mm, 75 mm and 100 mm, accordingly.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A, 1B and 1C are schematic representations in 2D and 3D of a shaving device, according to some embodiments of the invention;

FIGS. 2A, 2B and 2C are schematic representations of an exemplary shaving head, according to some embodiments of the invention;

FIG. 2D is a schematic representation of an exploded view of an exemplary shaving head, according to some embodiments of the invention;

FIG. 3 is a schematic representation of an exemplary wheel, according to some embodiments of the invention;

FIG. 4 is a schematic representation of an exemplary cover holder, according to some embodiments of the invention;

FIGS. 5A, 5B and 5C are schematic representations of a blade holder, according to some embodiments of the invention;

FIG. 6 is a schematic representation of a comparison between angles used in prior art blades and angles used in the blades of the invention, according to some embodiments of the invention;

FIGS. 7A and 7B are schematic representation of a bottom view of the shaving device and a side cross view of the shaving device, respectively, according to some embodiments of the invention;

FIGS. 8A-8H are schematic representations of an exemplary shaving device comprising three or more blades, according to some embodiments of the invention; and

FIGS. 9A-9C, showing schematic representations of exemplary shaving devices comprising a lubricant wheel, according to some embodiments of the invention.

### DESCRIPTION OF SPECIFIC EMBODIMENTS OF THE INVENTION

The present invention, in some embodiments thereof, relates to a shaving device and, more particularly, but not exclusively, to a shaving device for the body which can be easily over the surfaces of the body.

### Overview

An aspect of some embodiments of the invention relates to a device for shaving body surfaces. In some embodiments, the device is configured to shave hairs from a surface of a body when actuated in more than one direction. In some embodiments, the device is a bi-directional device configured to remove hair when actuated back and forth. In some embodiments, the device comprises at least one blade comprising two sharp edges or two blades, each comprising a single sharp end. In some embodiments, the blade(s) are positioned at an angle that is close to be parallel, but not completely parallel, to the surface being shaved. In some embodiments, the blade(s) are positioned at an angle of from about 5 degrees to about 10 degrees from the surface being shaved, preferably at an angle of 5 degrees. A potential advantage of having the blades at an angle of about 5 degrees is that it potentially allows a safe shaving for non-tense surfaces, like the skin on the body, which is less tense than the skin in the face.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Shaving Device

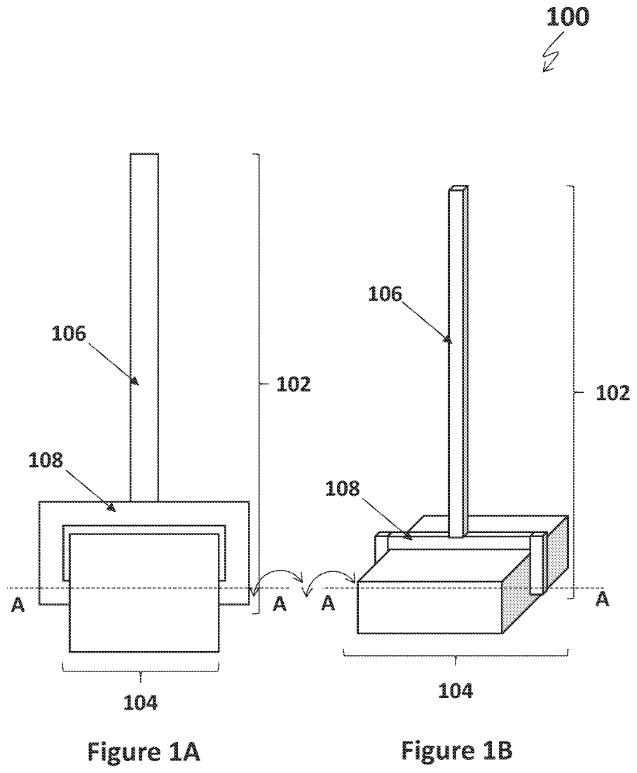

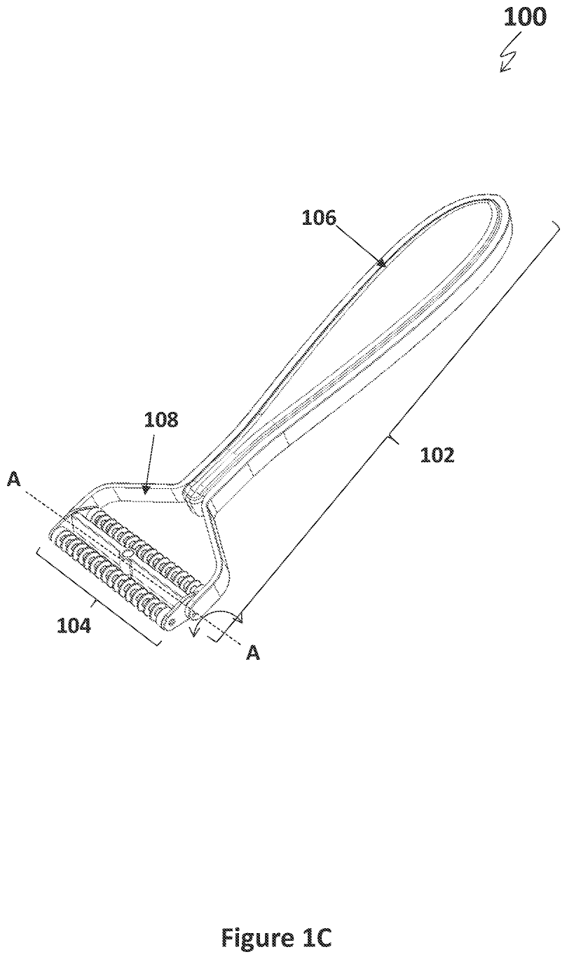

Referring now FIGS. 1A, 1B and 1C, showing schematic representations in 2D and 3D of a shaving device, according to some embodiments of the invention. In some embodiments, an exemplary shaving device 100 comprises a handle 102 and a shaving head 104. In some embodiments, the handle 102 comprises an elongated body 106 adapted to be hand held by a user. In some embodiments, the elongated body 106 comprises one or more ergonomic features/elements (not shown) to ease the use of the shaving device 100, for example one or more grippers and/or protrusions, optionally made of rubber or other anti-slippery material. In some embodiments, the handle 102 comprises a connecting structure 108 configured to reversibly connect between the elongated boy 106 of the handle 102 and the shaving head 104. In some embodiments, the connecting structure is characterized by an inverted “U”-like structure or two-arm structure, optionally adjustable, configured to be connected to the shaving head 104 from the sides, and, in addition, to provide a certain freedom of movement of the shaving head 104 in relation to the elongated body 106 of the handle, along an axis AA, as schematically shown by dotted line AA in FIGS. 1A-1C. In some embodiments, the reversibly connection of the handle 102 to the shaving head 104 is performed by one or more connecting mechanisms, for example, a groove-protrusion mechanism, a pin mechanism, a clamp mechanism or any other connecting mechanisms known in the art. In some embodiments, the shaving device 100 is configured to shave when moved back and forth, meaning the shaving device is a bi-directional shaving device. In some embodiments, the shaving head is configured to tilt in relation to the handle along a longitudinal axis where the handle is connected to the shaving head. In some embodiments, the tilting is limitless, meaning that the shaving head is allowed to rotate freely. In some embodiments, the tilting is restricted to a determined angle, for example from about ±5° to about ±25°, optionally from about ±3° to about ±45°, optionally from about ±1° to about ±90°.

### Exemplary Shaving Head

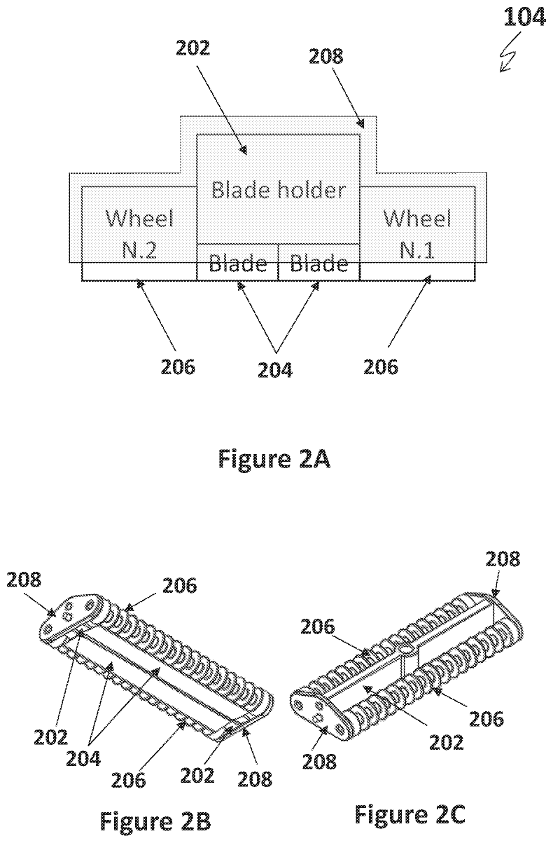

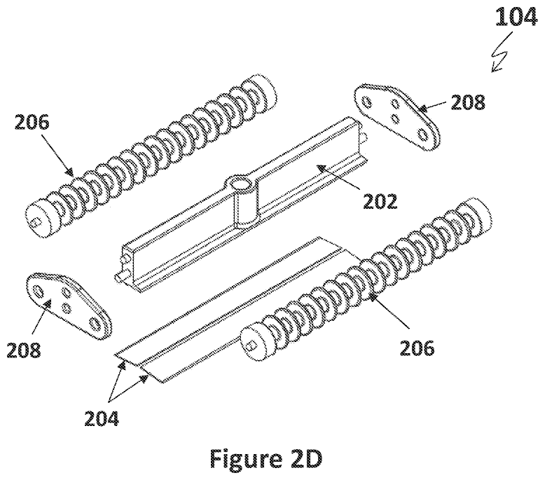

Referring now to FIGS. 2A-2C, showing schematic representations of an exemplary shaving head, according to some embodiments of the invention. In some embodiments, the shaving head comprises a blade holder 202, configured to hold or more blades 204, optionally at least two blades 204, which are held by the blade holder 202, each blade 204 having a sharp end pointing towards a wheel 206. In some embodiments, the shaving head 104 comprises one or more wheels 206, optionally at least two wheels 206, positioned on the sides of the blade holder 202 and the sharp end of the one or more blades 204. In some embodiments, the shaving head 104 comprise two cover holders 208 on the sides of the shaving head 104, configured to provide support to the different parts of the shaving head 104, for example, on the inside it provides support to the wheels 206, to the blade holder 202 and to optional reinforcing tubes (not shown), while from the outside, the cover holders 208 comprise the connecting mechanisms for attaching the handle 102.

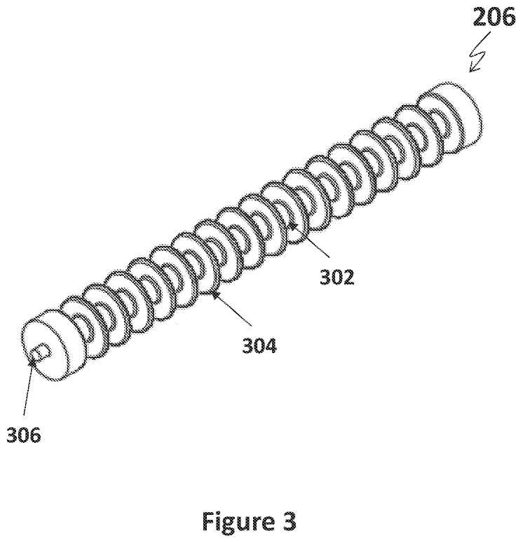

Referring now to FIG. 2D, showing a schematic representation of an exploded view of an exemplary shaving head, according to some embodiments of the invention. In some embodiments, as mentioned above, the shaving head 104 comprises a blade holder 202 to which one or more blades 204 are attached to a bottom side of the blade holder 202. In some embodiments, the sheaving head 104 comprises one blade 204 comprising two sharpened sides. In some embodiments, the shaving head 104 comprises two blades 204 having each one sharpened side. In some embodiments, the shaving head comprises two wheels 206. In some embodiments, the wheels 206 are configured to rotate freely. In some embodiments, the wheels 206 do not comprise a continuous body, rather comprise a plurality of intercalated small wheels 304 separated by a plurality of spaces 302, as schematically shown in FIG. 3. In some embodiments, the width of the small wheels is from about 0.2 mm to about 0.6 mm, optionally from about 0.1 mm to about 1 mm, optionally, from about 0.1 mm to about 1.5 mm. For example, the width of the small wheels is 0.4 mm, 0.5 mm, 0.6 mm. Optionally having a width larger than 1.5 mm. In some embodiments, the distance between the small wheels is from about 1 mm to about 4 mm. Optionally from about 0.5 mm to about 5 mm. Optionally from about 0.1 mm to about 10 mm. In some embodiments, the wheels comprise connecting pins 306 located on the side and configured to be positioned within openings 402 in the cover holder (see below). In some embodiments, the wheels provide at least two functions: on one side, the wheels keep the blades from achieving a damaging angle against the surface; and on the other side, the spaces 302 between the small wheels 304 guide hairs towards the blades and facilitate cutting long hairs by moving them from laying position to a standing position. In some embodiments, the wheels 206 comprise a diameter from about 3 mm to about 10 mm, optionally from about 2 mm to about 15 mm, optionally from about 1 mm to about 20 mm. For example, 5 mm, 7 mm, 12 mm. Optionally larger than 20 mm. Optionally shorter than 1 mm.

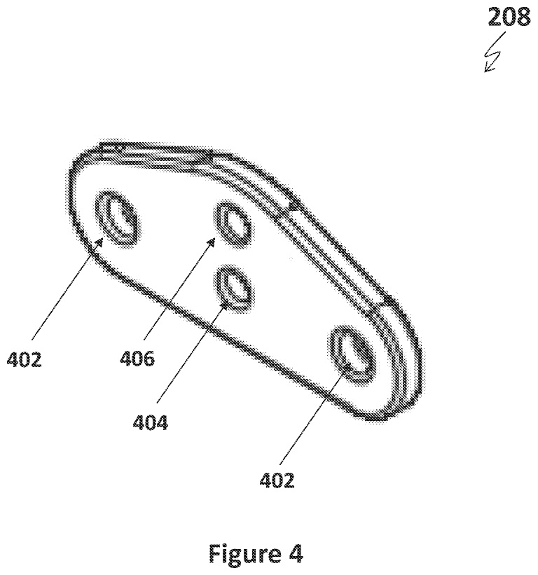

In some embodiments, the shaving head 104 further comprises two cover holders 208, as also schematically shown in FIG. 4. In some embodiments, the cover holders 208 are configured to provide support to the different parts of the shaving head. In some embodiments, the two wheels 206 are positioned within openings 402 in the cover holder 208. In some embodiments, the blade holder 202 comprises two pins (see below) configured to be inserted in openings 404 and 406 in the cover holder 208. In some embodiments, one of the pins of the blade holder 202 is longer than the other and protrudes beyond the surface of the cover holder 208. In some embodiments, the protruding pin is used to attach the handle 102 to the shaving head 104.

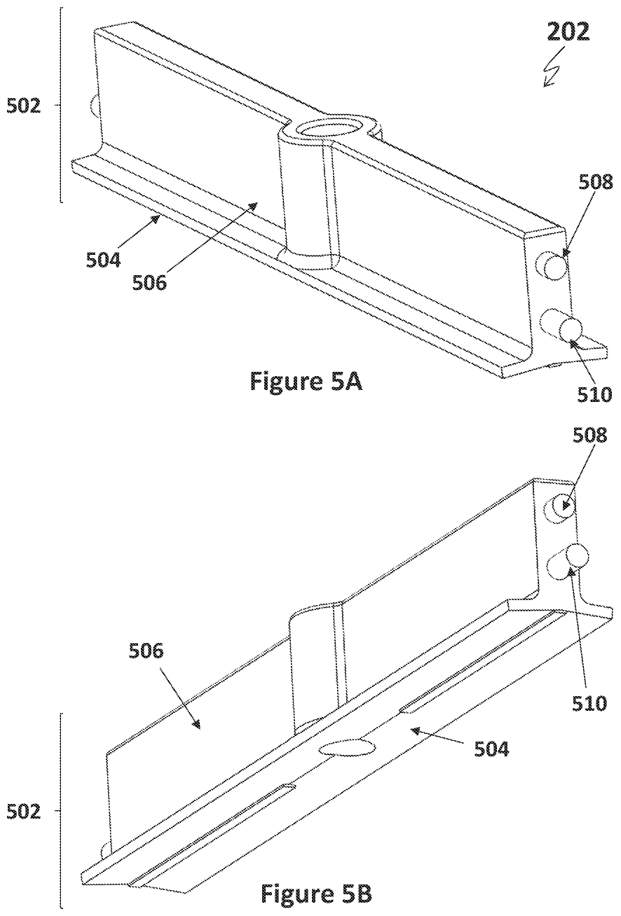

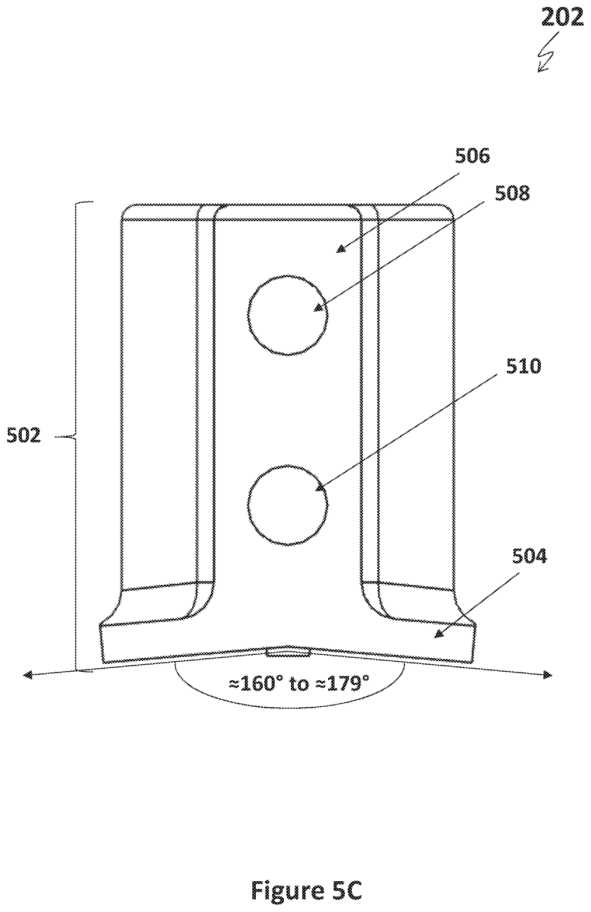

Referring now to FIGS. 5A-5C, showing schematic representations of a blade holder 202, according to some embodiments of the invention. In some embodiments, the blade holder 202 comprises an elongated body 502 having a base 504 and a rib 506 extending vertically from the center of the base 504. In some embodiments, on the sides of the blade holder 202 there are two pins 508 and 510, where optionally, pin 510 is longer than 508. In some embodiments, the pins 508/510 are configured to secure the blade holder 202 to the cover holder 208. In some embodiments, the longer pin 510 is used to secure the handle 102 to the shaving head 104. In some embodiments, the bottom of the base 504 is not flat. In some embodiments, the bottom of the base 504 comprises an angle of from about 179 degrees to about 160 degrees, as schematically shown in FIG. 5C. In some embodiments, the bottom of the base provides the blades 106 with an angle of from about 1 degree to about 10 degrees in relation to the surface being shaved.

In some embodiments, exemplary dimensions of the shaving head are:

Width: from about 20 mm to about 50 mm, optionally from about 15 mm to about 80 mm, optionally from about 10 mm to about 100 mm. For example, 23 mm, 46.2 mm, 55 mm. Optionally larger than 100 mm. Optionally shorter than 10 mm.

Depth: from about 10 mm to about 20 mm, optionally from about 5 mm to about 25 mm, optionally from about 3 mm to about 50 mm. For example, 12 mm, 16 mm, 30 mm. Optionally larger than 50 mm. Optionally shorter than 3 mm.

Height: from about 5 mm to about 10 mm, optionally from about 3 mm to about 15 mm, optionally from about 1 mm to about 20 mm. For example, 4 mm, 6.77 mm, 12 mm. Optionally larger than 20 mm. Optionally shorter than 1 mm.

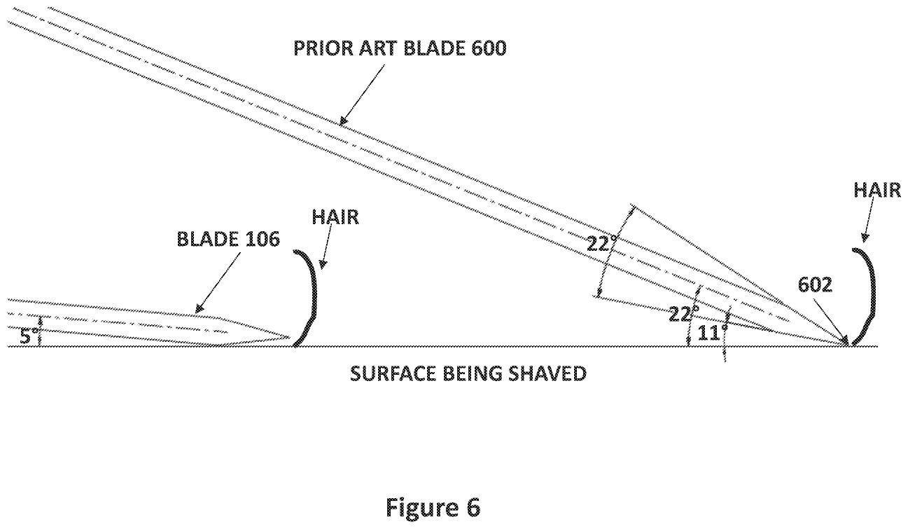

Referring now to FIG. 6, showing a schematic representation of a comparison between angles used in prior art blades and angles used in the blades of the invention, according to some embodiments of the invention. Blades 600 in prior art devices comprise a sharp edge having a 22 degree angle (two sharp sides of 11 degrees each) finishing in a sharp tip 602. In some embodiments, the sharp tip 602 is the first part of the blade that meets the hair being shaved and usually the sharp tip 602 is moved along the surface that is being shaved in order to shave the hair at the closest level in relation to the surface. Additionally, the blades 600 in the prior at devices are usually positioned at an angle of about 22 degrees in relation to the surface being shaved, when measured from a longitudinal axis of the blade 600. This causes the blade 600 to move at an angle of about 11 degrees in relation to the surface being shaved, when measured from a longitudinal axis of the blade 600.

In some embodiments, the blade 106 of the shaving device 100 is positioned so it is positioned at an angle of from about 1 degree to about 10 degrees in relation to the surface being shaved, when measured from a longitudinal axis of the blade 106. Optionally, the blade 106 of the shaving device 100 is positioned so it is positioned at an angle of about 5 degrees in relation to the surface being shaved, when measured from a longitudinal axis of the blade 106, as shown for example in FIG. 6. In some embodiments, the blade 106 of the shaving device 100 is positioned so the tip of the blade is not being dragged along the surface that is being shaved, when the shaving device 100 is being used. A potential advantage of positioning the blade at an angle of about 5 degrees in relation to the surface being shaved, when measured from a longitudinal axis of the blade 106 and or not dragging the sharp tip of the blade 106 along the surface being shaved is that it potentially allows shaving non-tense surfaces (for example, body skin) securely.

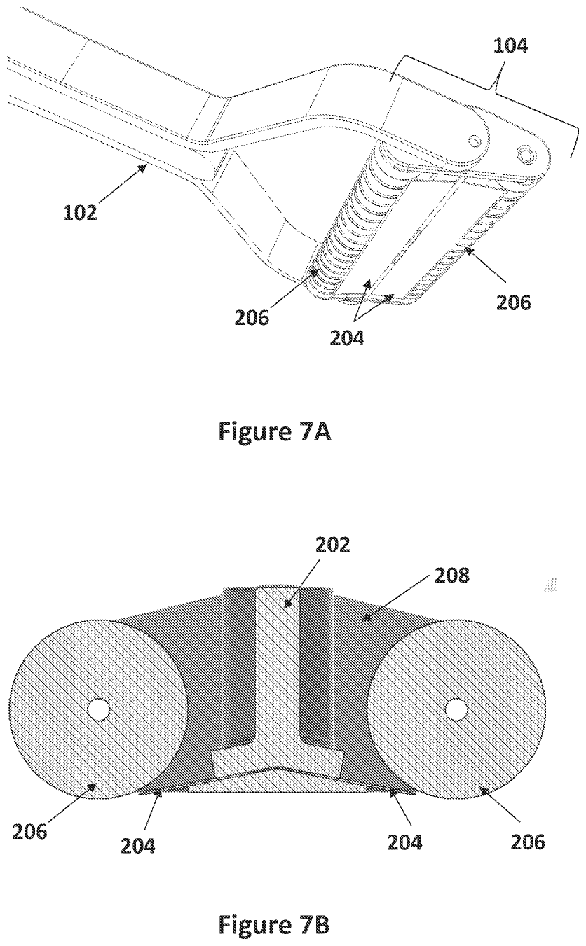

Referring now to FIGS. 7A-7B showing a schematic representation of a bottom view of the shaving device and a side cross view of the shaving device, respectively, according to some embodiments of the invention. In some embodiments, the blades 204 of the shaving device 100 are positioned adjacent to the wheels 206. In some embodiments, as mentioned above, the wheels provide stability to the device and potentially avoid from the blades to achieve an angle that might damage the surface that is being shaved.

### Exemplary Three or More Blades

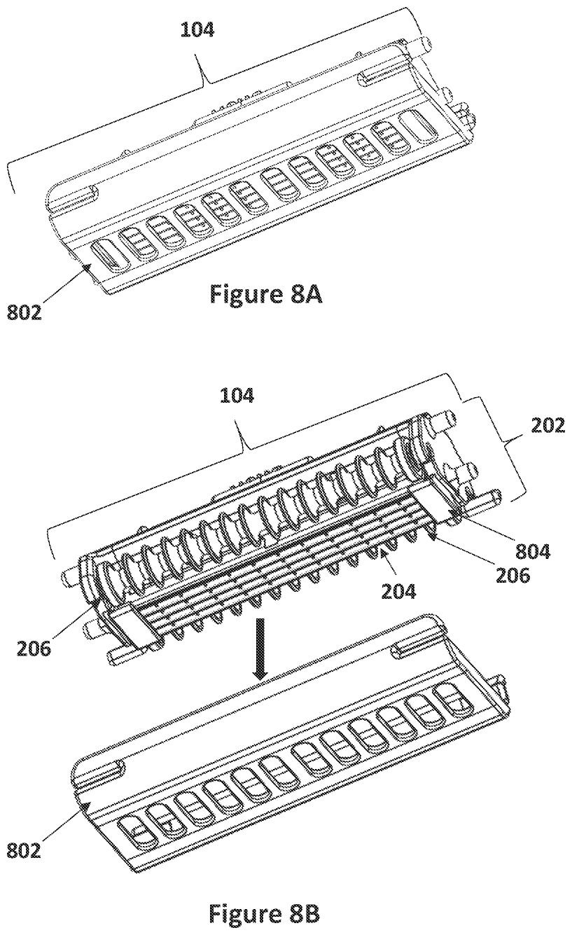

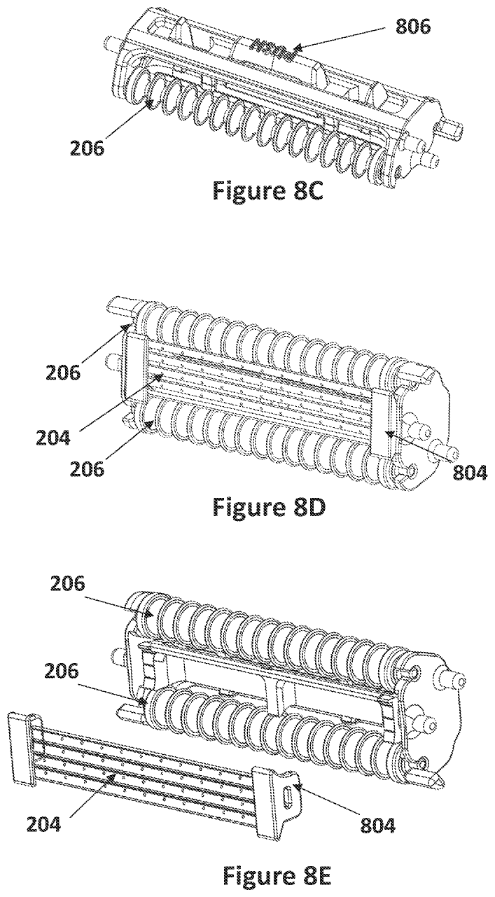

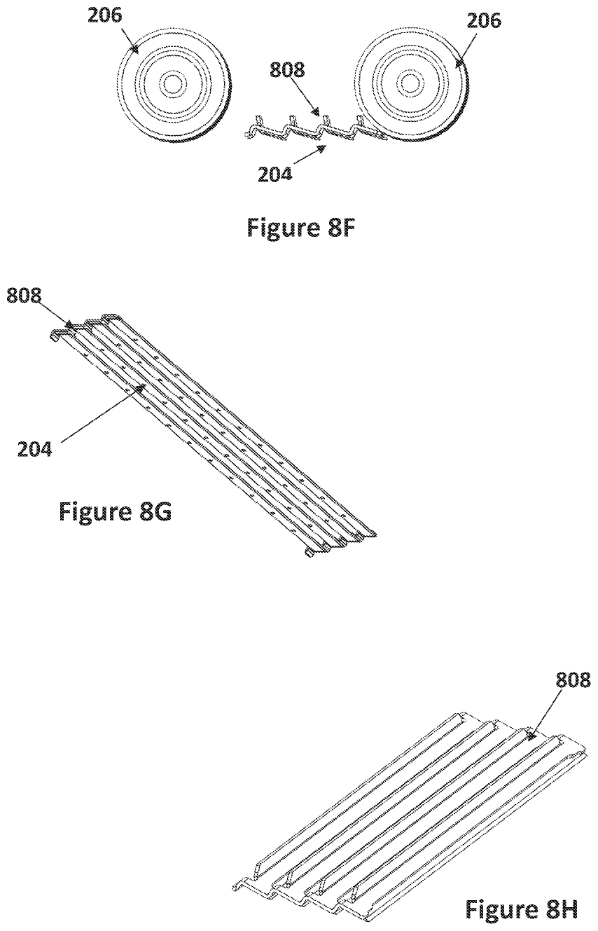

Referring now to FIGS. 8A-8H showing schematic representations of an exemplary shaving device comprising three or more blades, according to some embodiments of the invention. In some embodiments, the shaving head 104 is provided with a protective cover 802 configured to cover the blades 206 and protect the user and the blades 206, as shown for example in FIG. 8A. In some embodiments, the protective cover 802 is provided with any of the abovementioned exemplary embodiments of shaving devices. In some embodiments, the protective cover 802 is removed before using the shaving device, as schematically shown for example in FIG. 8B. In some embodiments, an exemplary shaving device comprises more than one blade 204. In some embodiments, for example as shown in FIGS. 8B-8H, the device comprises two or more blade, optionally three or more blades. In some embodiments, the plurality of blades are all organized to have the sharp end facing at a same direction, as shown for example in FIGS. 8A-8H. In some embodiments, not shown in these figures, the plurality of blades are positioned so a number of blades face to one direction, while a number of blades face the opposite direction, as shown for example in FIGS. 2A-D, 5C and 7A-7B. In some embodiments, independently of the number of blades or their directionality, an exemplary shaving head comprises the two wheels 206, as previously explained. In some embodiments, the shaving head 104 comprises a release button 806, configured to actuate a release mechanism configured to release the blades, as schematically shown in FIGS. 8C, 8D and 8E. In some embodiments, the plurality of blades 204 are mounted on a blade-holder 804. In some embodiments, releasing the plurality of blades comprises releasing the blade-holder 804. In some embodiments, the release mechanisms allow a user to replace the blades alone while keeping the rest of the shaving device. In some embodiments, this is useful in case where the shaving device is multiuse. In some embodiments, the shaving device is a one-time-use shaving device. In some embodiments, the blade-holder 804 comprises a plurality of steps configured to receive in each step a blade, as schematically shown in FIGS. 8F, 8G and 8H. In some embodiments, the number of steps in the blade-holder 804 is the same as the number of blades. In some embodiments, the angle of the steps is such as to position the blades at the desired angle, as explained above, and as schematically shown in FIG. 8F.

### Exemplary Lubricant

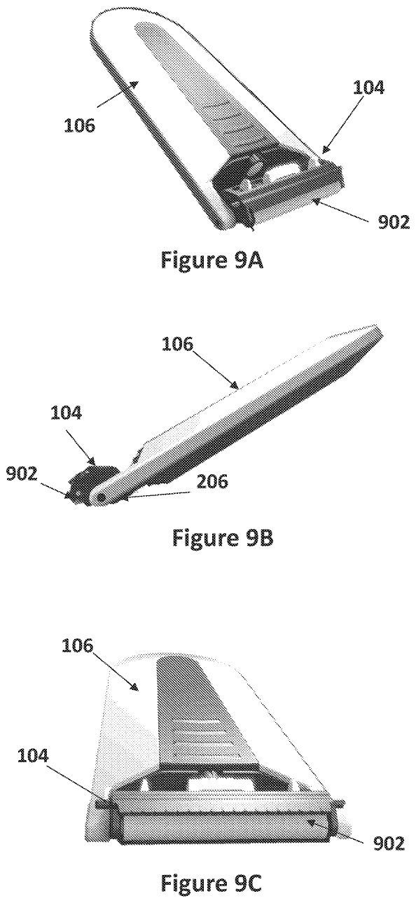

Referring now to FIGS. 9A-9C, showing schematic representations of exemplary shaving devices comprising a lubricant wheel, according to some embodiments of the invention. In some embodiments, one or both wheel of the shaving device comprise a lubricant sheet 902 configured for releasing lubricant material while the wheel is being rotated over the skin. In some embodiments, the lubricant material can be any material that enhances the shaving experience.

### Exemplary Kit

In some embodiments, a kit is provided comprising: an adjustable handle and a plurality of shaving heads, each having a different dimension. For example, a plurality of heads each having a length of 5 mm, 10 mm, 20 mm, 23 mm, 45 mm, 46.2 mm, 50 mm, 75 mm and 100 mm, accordingly.

In some embodiments, the user mounts and dismounts the shaving head according to his needs.

As used herein with reference to quantity or value, the term “about” means “within ±20 % of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A shaving device for shaving a surface, comprising:
a. a handle, comprising an elongated body having a proximal end and a distal end; and
b. a shaving head, connected to said distal end of said handle, said shaving head comprising:
i. a blade holder comprising a bottom side for connecting at least two blades thereto;
ii. at least two blades, each comprising at least one sharp end;
iii. a first plurality of wheels and a second plurality of wheels, each of the first plurality of wheels and the second plurality of wheels being located adjacent at least one of said at least one sharp end of each of said at least two blades;
wherein said bottom side of said blade holder comprises an angle that positions each of said at least two blades at an angle between about 1 degree and about 10 degrees in relation to said surface being shaved.

2. The shaving device according to claim 1, wherein said angle is 5 degrees.

3. The shaving device according to claim 1, wherein at least one of the at least two blades has two sharp ends.

4. The shaving device according to claim 1, wherein the wheels of said first plurality of wheels are spaced apart by a first plurality of spaces and the wheels of said second plurality of wheels are spaced apart by a second plurality of spaces.

5. The shaving device according to claim 4, wherein a width of each wheel of said first plurality of wheels and said second plurality of wheels is from about 0.2 mm to about 0.6 mm.

6. The shaving device according to claim 4, wherein a width of each wheel of said first plurality of wheels and said second plurality of wheels is 0.6 mm.

7. The shaving device according to claim 4, wherein each of said plurality of spaces is from about 1 mm to about 4 mm.

8. The shaving device according to claim 1, wherein said shaving head is configured to tilt along a longitudinal axis of said shaving head, said longitudinal axis meeting a location where said handle connects to said shaving head.

9. The shaving device according to claim 8, wherein said tilt is at an angle of from about ±1° to about ±90°.

10. The shaving device according to claim 8, wherein said shaving head freely rotates along said longitudinal axis.

11. The shaving device according to claim 1, wherein said handle comprises a two arm structure configured to interlock with sides of said shaving head for performing the connection between said handle and said shaving head, said shaving head being reversibly connectable to said handle.

12. The shaving device according to claim 11, wherein said two arm structure is adjustable.

13. The shaving device according to claim 1, wherein said blade holder further comprises a base, wherein said bottom side is a bottom side of said base, and further comprising a rib extending vertically from a center of said base.

14. The shaving device according to claim 1, wherein said first plurality of wheels and said second plurality of wheels are configured to rotate freely.

15. The shaving device according to claim 1, wherein each wheel of said first plurality of wheels and each wheel of said second plurality of wheels comprises a diameter of from about 1 mm to about 20 mm.

16. The shaving device according to claim 1, wherein each wheel of said first plurality of wheels and each wheel of said second plurality of wheels comprises a diameter of 5 mm.

17. The shaving device according to claim 1, wherein said shaving device further comprises two cover holders configured to provide support for the parts of said shaving head.

18. The shaving device according to claim 17, wherein each of said two cover holders comprises a plurality of openings configured to engage parts of said shaving head.

19. (canceled)

20. (canceled)

21. (canceled)

22. (canceled)

23. (canceled)

24. (canceled)

25. (canceled)

26. (canceled)

27. (canceled)

28. The shaving device according to claim 1, wherein a first blade of said at least two blades faces to a first direction and wherein a second blade of said at least two blades faces to a second direction that is opposite the first direction.

29. The shaving device according to claim 1, wherein all blades from said at least two blades faces a same direction.

30. (canceled)

31. (canceled)

32. (canceled)
